(19) United States
(12) Patent Application Publication
(10) Pub. No.: US 2007/0179252 A1
(43) Pub. Date: Aug. 2, 2007

(54) Photochromic molding compositions and articles produced therefrom

(75) Inventors: Nikolai Lamberts, Bonaduz (CH); Friedrich Severin Buhler, Thusis (CH); Ralf Hala, Lindenberg (DE)

Correspondence Address: SUGHRUE MION, PLLC, 2100 PENNSYLVANIA AVENUE, N.W., SUITE 800, WASHINGTON, DC, 20037, US

(73) Assignee: EMS-CHEMIE AG, Domat/Ems (CH)

(21) Appl. No.: 11/656,986

(22) Filed: Jan. 24, 2007

(30) Foreign Application Priority Data
Jan. 27, 2006 (EP) 06405037.0

(51) Int. Cl. C08L 77/00

(52) U.S. Cl. 525/432

(57) ABSTRACT

A polyamide molding composition is described, comprising a proportion by weight of from 50 to 99% by weight of at least one transparent homopolyamide and/or copolyamide, a proportion by weight of from 1 to 50% by weight of at least one further polymer whose glass transition temperature is below 80° C., and also a proportion by weight of from 0.001 to 2.0% by weight of at least one photochromic dye. Further dyes and/or additives can optionally be present. The invention moreover encompasses articles manufactured therefrom, a particular example being photochromic ophthalmic lenses.

### TECHNICAL FIELD

The present invention relates to photochromic molding compositions and to articles produced therefrom, e.g. ophthalmic lenses, and also to processes for production of such articles. These are preferably bulk-colored molding compositions, but coloring in a dip-coating bath or by way of another method of introducing/doping the photochromic dye is likewise possible.

### PRIOR ART

Photochromic molding compositions are starting materials used for production of photochromic articles, e.g. sunglass lenses which undergo reversible tinting on exposure to light, or similar articles.

Photochromic means that the dye is converted to an excited state via exposure to light (UV or short-wave VIS), the unexcited, thermodynamically state and the excited state here having different absorption spectra (cf. definition of Photochromie [Photochromicity] in: Römpp Lexikon Chemie [Römpp's Chemical Encyclopedia], 10th edition, page 3303, Georg Thieme Verlag, Stuttgart). The excited state generally has an intense color, whereas the initial form is colorless. The excited dye molecule returns to the unexcited state via a thermal or radiation-induced reverse reaction.

These dyes can be used to produce optical filters whose variability is light-induced, for example by introducing the dye into a plastics matrix (bulk coloring), or by applying a coating with dye onto glass or plastic (cf., for example, J. F. Rabek in Mechanisms of Photophysical Processes and Photochemical Reactions in Polymers, chapter 10, pages 377-391, for incorporation of such dyes into polymeric matrices).

An important application is provided by ophthalmic lenses, e.g. sunglass lenses, which spontaneously darken when subject to insolation. A plurality of photochromic dyes and/or one or more inert dyes together with the photochromic dye are used in order to give these lenses the desired shade of color. If an inert dye is used, the lens, even in the non-irradiated state, has an underlying tint or a color, and this reduces transmittance.

A significant aspect of such applications is that the number of possible repeats of the reversible photochromic process has been maximized, and that the dye is not irreversibly removed from this cycle by environmental effects (e.g. oxygen) or side reactions (e.g. with the polymer matrix or with additives). A further precondition is that the “switching process” (excitation) and/or the thermal reverse reaction proceed(s) to practical completion within an acceptable period. If this is not the case, tinting of the lens does not occur on exposure to light (no reduction in transmittance), and/or the lens retains its tint for a long time after exposure to light. Both are undesired.

Marketing of the first photochromic plastic lenses began as early as 1980. However, numerous improvements in the dyes and in the polymeric matrices had to be achieved before the photochromic system achieved adequate lifetime and satisfactory spectral performance. Initially, such plastics lenses were practically entirely based on cast systems, e.g. allyl diglycol carbonate CR39, which is obtainable via polymerization of bisallyl carbonates. Later, lenses based on (meth)acrylates and on polycarbonates also became available, and recently an increasing number of lenses is produced thermoplastically, the materials often used here being thermoplastic polyurethanes (TPU).

Some disclosures from the patent literature in the general context of photochromically doped plastics will be described below. There are intentionally no details given of the wide variety of descriptions of systems such as CR39 which are processed in a casting process with crosslinking to give lenses, since the present invention does not encompass such systems.

JP-A-63027837 describes a photochromic system in which a PET (polyethylene terephthalate) plastics matrix with which a plasticizer has been admixed (from 2 to 15% by weight) is doped with a photochromic dye. The intention of this selection of the matrix is that the long-term stability of such a layer be improved, under constant exposure to light and heat, and this layer can, for example, be applied to a nylon film.

JP-A-01180536 likewise describes a photochromic material intended to be heat-resistant and weather-resistant. It is composed of a plastics matrix composed of a transparent plastic and of an additive which is a polymer having a defined proportion of monomers having hydroxyl groups, e.g. PVB (polyvinyl butyral) or polyvinyl acetate. A wide variety of possible systems is stated as transparent plastic, examples being PMMA, PC, transparent nylon, etc.

JP-A-01024740 is like the two abovementioned specifications from the tinted vehicle windshields sector in describing a multilayer structure composed of two glass layers with an intermediate layer which comprises a photochromic material. A plurality of possibilities is stated as transparent material of this intermediate layer, inter alia vinyl resin, acrylic resin, polyester resin, and polyamide resin. Spirooxazines inter alia are mentioned as dyes, and a specific distribution of the dye is emphasized as advantageous.

WO 01/49478 describes a photochromic lens which is composed of a PC substrate and of a photochromically doped coating composed of thermoplastic polyurethane (TPU). This coating is applied to a PC preform in an in-mold-coating process.

### BRIEF DESCRIPTION OF THE INVENTION

The invention is therefore based inter alia on the object of providing a photochromic material improved in comparison with the materials of the prior art. A particular object is improvement of such materials based on polyamides.

This object is achieved in particular by providing a photochromic polyamide molding composition which comprises a proportion by weight of from 50 to 99% by weight of at least one transparent homopolyamide and/or copolyamide, a proportion by weight of from 1 to 50% by weight of at least one further polymer whose glass transition temperature is below 80° C., and also a proportion by weight of from 0.001 to 2.0% by weight of at least one photochromic dye. This material can optionally comprise, inter alia, further dyes and/or additives. It is not necessary that photochromic dye has been previously admixed with this material, and it is also possible to use the mixture composed of polyamide and of other polymer with the properties mentioned in relation to glass transition temperature as initial charge and to introduce the dye into the article, e.g. in a dip-coating bath, after or during production of an article (e.g. production of a lens in an injection-molding process).

The further polymer preferably has at least one amorphous phase whose glass transition temperature is at most 80° C. If the further polymer is a block polymer having a soft segment, the glass transition temperature of the soft segment should be below 40° C., preferably below 25° C.

The term used in this specification “transparent polyamides” is intended to mean polyamides or copolyamides or molding compositions formed therefrom, their light transmittance being at least 70% when the (co)polyamide (in pure form, i.e. without the further constituents stated above of the inventive molding composition) takes the form of a thin plaque (plate), thickness 2 mm. Light transmittance is measured here on a Perkin Elmer UV/VIS spectrometer in the range from 200 to 800 nm, using round plaques measuring 70×2 mm. The transmittance value is stated for the wavelength range from 500 to 700 nm. The round plaques measuring 70×2 mm are produced for this purpose by way of example on an Arburg injection-molding machine in a polished mold, the cylinder temperature here being from 200 to 340° C. and mold temperature from 20 to 140° C.

Examples of transparent polyamides that can be used for these purposes are polyamides and/or copolyamides as described in DE-A-102 24 947, or DE-A-101 22 188, CH-A-688 624 or EP-A-0 725 100, or a mixture thereof. In relation to transparent polyamides, the disclosure of these documents and the polyamide systems and copolyamide systems mentioned therein are expressly incorporated into this description.

One of the advantages of the use of polyamides as main material is that, unlike materials such as CR39 or acrylate which have been used hitherto for production of ophthalmic lenses, these being materials which required traditional casting processes involving polymerization (crosslinking), transparent polyamides (amorphous or microcrystalline) can be processed in simple injection-molding processes with low cycle times, i.e. using low-cost mass production. The inventive polyamide molding composition is therefore also preferably not crosslinkable.

It is preferable that the mixture is composed of a proportion by weight of from 70 to 99% by weight, particularly from 80 to 98% by weight, of the transparent homopolyamide and/or copolyamide and of a proportion by weight of from 1 to 30% by weight, particularly from 2 to 20% by weight, of at least one further polymer whose glass transition temperature is below 80 or 40° C. (i.e. without dye), and the mixture is at the same time likewise preferably in essence transparent in the above sense or no more than 10%, or preferably 5%, less transparent than in the above sense. For components whose optical specification is less demanding, or for components in which the photochromic processes are relevant only in reflection (for example decorative items), lower transparency and even slight haze are also possible. For components with a demanding optical specification, transmittance above 70%, preferably above 80%, in the wavelength range from 500 to 700 nm (measured at a layer thickness of 2 mm) is preferred and/or haze less than 5 or even 3, and preferably less than 2 (ASTM 1003, layer thickness 2 mm).

Addition of polyamide-12 (also called polyamide-12), in particular of low-viscosity PA12 (solution viscosity or relative viscosity ηᵣₑₗ—according to DIN EN ISO 307 in a 0.5 weight % solution in m-cresol at 20° C.—from 1.5 to 2, preferably from 1.6 to 1.9) can improve haze and photochromic effect.

Addition of polyamide-12 and/or polyamide oligomer moreover makes it possible to process the photochromic polyamide molding composition under milder conditions and to incorporate the photochromic dye into the thermoplastic molding composition under milder conditions, and it is therefore possible to inhibit substantially any degradation of the unstable photochromic dye during the extrusion and/or injection-molding process. An example of a suitable polyamide oligomer is a polyamide-12 oligomer, preferably with average molar mass of from 1500 to 2500 g/mol, particularly preferably having mainly non-condensable alkyl end groups.

Various measures can be used to avoid gate marks. Addition of 10% by weight or more of a low-viscosity polyamide-12 can be effective in inhibiting formation of gate marks. Gate marks can likewise be avoided if the ratio of the solution viscosities of the transparent polyamide and of the polymer component whose glass transition temperature is below 80° C. is smaller than 1.2, in particular smaller than 1.1. Haze, too, is reduced as the ratio of the solution viscosities of the two polymer components falls, for identical chemical constitution. Addition of polyamide-12 oligomer makes processing easier overall, by virtue of lower melt viscosity and longer flow path.

Although it has been possible for some years to prepare amorphous polyamides, too, in the purity required for optical applications, examples being polyamides of type MACM12 as described in DE-A-196 42 885, these being available from EMS CHEMIE, Switzerland, with trade name Grilamid TR 90, simple addition of a photochromic dye cannot give satisfactory photochromic results in the lenses produced from these pure systems.

MACM here represents the compound whose ISO name is bis(4-amino-3-methylcyclohexyl)methane, which is commercially available as the C260 grade of Laromin (CAS No. 6864-37-5) with trade name 3,3′-dimethyl-4,4′-diaminodicyclohexylmethane. The numeral 12 represents an aliphatic linear C12 dicarboxylic acid (DDA, dodecanedioc acid), with which the diamine MACM has been polymerized.

Surprisingly, it has been found that, contrary to previous experience to the effect that addition of photochromic dyes to transparent polyamides does not give satisfactory photochromic behavior, the inventive material gives, when processed to give photochromic articles, unexpectedly long-lived, i.e. frequently repeatable, reversible photochromic behavior. Furthermore, the preferred dyes are among the most stable photochromic systems. The switching process (excitation) moreover proceeds rapidly and the thermal reverse reaction likewise proceeds almost to completion within a reasonable period from seconds to at most a few minutes.

Normally, only pure polyamide materials whose glass transition temperature is below 100° C., i.e. not those present in the form of a mixture, exhibit pronounced photochromic behavior, an example being MACM36 or PACM36, where PACM represents the compound whose ISO name is bis(4-aminocyclohexyl)methane, available as Dicykan grade (CAS No. 1761-71-3) with tradename 4,4′-diaminodicyclohexylmethane. However, the defective mechanical or thermal properties of these materials generally make them unsuitable by way of example for ophthalmic lens applications. Addition of a further polymer to a transparent (co)polyamide alongside the dye is possible. However, these polymers and the resultant mixture (blend) are subject to stringent requirements, particularly for ophthalmic lens applications, and admixture normally results in haze in the blend. However, optical properties (transmittance, haze, Abbe number) of the mixtures (blends) should not be substantially below the level of the pure polyamides. The photochromic process should have good kinetics (darkening and fading within period from seconds to a few minutes, preferably within from 20 to 60 seconds) and continue over a long lifetime. This is the case with the proposed materials and with the articles produced therefrom. As previously mentioned, these good properties of the bulk-colored articles also occur when the article is manufactured from the blend without dye and the dye is introduced after the initial molding of the article, e.g. in a dip-coating bath. The presence of the other polymer with low glass transition temperature alongside the transparent polyamide provides an environment for the photochromic dyes permitting the reversible changes of configuration and/or of conformation which mostly occur during excitation of the dyes and which are generally required for the color change.

In one first preferred embodiment, the polyamide molding composition is one where the glass transition temperature of the further polymer is below 30° C., preferably below 25° C. This can give ideal photochromicity kinetics. Good values are obtained particularly when the glass transition temperature of the further polymer is below 0° C., preferably in the range from (−60)-(−20)° C.

Another preferred embodiment with excellent kinetics is one wherein the further polymer is a polyamide based on cycloaliphatic diamines and aliphatic dicarboxylic acids having from 6 to 40 carbon atoms, particularly preferably having from 20 to 36 carbon atoms, the cycloaliphatic diamine preferably being MACM and/or PACM, and the entire polyamide particularly preferably being MACM36 and/or PACM36, and/or wherein the further polymer is a block copolymer having soft segments, where the glass transition temperature of the soft segments is preferably below 25° C. The further polymer can, for example, be a polyamide block copolymer having soft segments, preferably a polyamide-12 block copolymer, the soft segments here preferably being polyether soft segments and/or polyester soft segments and/or polysiloxane soft segments and/or polyolefin soft segments and/or polyacrylate soft segments. Preferred polyether segments are those based on the monomers ethylene oxide and/or propylene oxide and/or tetrahydrofuran.

Possible other further polymers are also polyester elastomers having soft segments and TPU elastomers having soft segments, both of these being as previously described at an earlier stage above in connection with polyamide block polymers. It is also possible to use other further polymers, as long as they meet the glass-transition-temperature conditions stated above, examples being acrylate polymers, methacrylate polymers (particularly preferably having long pendent groups), polycarbonate copolymers, styrene copolymers (preferably based on acrylonitrile, butadiene, acrylate, methacrylate), polyolefins, particularly grafted, ethylene copolymers (based on propene, butene, pentene, hexene, octene, decene, undecene, butadiene, styrene, acrylonitrile, isoprene, isobutylene, or being derivatives of (meth)acrylic acid, vinyl acetate, tetrafluoroethylene, vinylidene fluoride, hexafluoropropene and 2-chlorobutadiene), polyisobutylene, polybutyl acrylate, and others.

In one preferred embodiment, the transparent homopolyamide and/or copolyamide is a polyamide based on cycloaliphatic diamines and on aliphatic dicarboxylic acids having from 6 to 36 carbon atoms, or is a mixture of such homopolyamides and/or copolyamides. Excellent transparency values with good photochromicity are obtained by way of example when the cycloaliphatic diamines are MACM and/or PACM and/or when the aliphatic dicarboxylic acid is an aliphatic dicarboxylic acid having 10, 12, or 18 carbon atoms. For example, the transparent polyamide can be a homopolyamide selected from the group of MACM12 (e.g. Grilamid TR 90, cf. text further below), MACM18, and/or is a copolyamide selected from the group of MACM12/PACM12, MACM18/PACM18. It is preferable that the refractive index of such systems is greater than or equal to 1.50, the Abbe number being greater than or equal to 40 and the density being smaller than or equal to 1.1 g/cm³.

Another advantageous possibility is that the transparent homopolyamide and/or copolyamide is a polyamide based on aromatic dicarboxyic acids having from 8 to 18 carbon atoms or is a mixture of such homopolyamides and/or copolyamides, preferably based on lactams and/or aminocarboxylic acids, where the aromatic dicarboxylic acids are by way of example TPA (terephthalic acid) and/or IPA (isophthalic acid). The transparent homopolyamide and/or copolyamide can advantageously be a polyamide selected from the group of: 6I6T, TMDT, 6I/MACMI/MACMT, 6I/6T/MACMI, MACMI/MACM36, 6I, lactam-containing polyamides, such as 12/PACMI, 12/MACMI, 12MACMT, 6/PACMT, 6/6I, 6/IPDT, or a mixture thereof. The polyamides are designated pursuant to ISO 1874-1. Each I here represents isophthalic acid and each T here represents terephthalic acid, TMD represents trimethylhexamethylenediamine, IPD represents isophoronediamine.

It is advantageous and possible that the transparent homopolyamide and/or copolyamide is a polyamide based on at least one dicarboxylic acid and on at least one diamine having an aromatic ring, preferably based on MXD (meta-xylylenediamine), where the dicarboxylic acid can be aromatic and/or aliphatic, the material preferably being 6I/MXDI.

It is preferable that the refractive index of such systems and generally of the transparent homopolyamide and/or copolyamide is greater than or equal to 1.59, the Abbe number being greater than or equal to 25 and the density being smaller than or equal to 1.3 g/cm³. It is preferable that the solution viscosity or relative viscosity ηᵣₑₗ (according to DIN EN ISO 1628-1 or DIN EN ISO 307) is from 1.3 to 2.0, in particular from 1.40 to 1.85. The glass transition temperature T_{g} of the transparent homopolyamide and/or copolyamide is moreover normally above 90° C., preferably above 110° C., particularly preferably above 130° C.

Another preferred embodiment is one wherein the photochromic dye is a dye which is reversibly excitable with UV or short-wave VIS, preferably being a dye based on spirooxazines. Excitable means that it can be excited to a state in which its absorption spectrum alters in such a way that absorption of visible light takes place, when the dye has been embedded in the matrix composed of polymer, i.e. in the inventive blend composed of transparent polyamide and of other polymer with the glass transition temperature stated above. The achievable filter effect can be adjusted widely in the visible region of the spectrum via the selection of the photochromic dyes and adjustment of the concentration. It is therefore possible to achieve a completely reversible reduction to 40% or even 10% of the original transmittance (generally from 80 to 92%) (in each case measured on a plaque of thickness 1 or 2 mm with parallel sides).

Other possible dyes which can be incorporated as photochromic systems are described by way of example in Kirk-Othmer Encyclopedia of Chemical Technology vol. 6, “Chromogenic Materials, Photochromie”, pages 587-605, John Wiley and Sons, Inc., or else in: Heinz Dürr, Henri Bouas-Laurent (eds.), Photochromism: Molecules and Systems, Elsevier 2003. These dyes are expressly incorporated into the present disclosure content for incorporating into the inventive blends, preference being given to the spirooxazines described in these publications. Other possible systems are particularly those described in DE-A-36 22 871, or described in WO 2005/030856, or described in EP-A-0 313 941. These dyes, too, are expressly incorporated herein by way of reference.

The abovementioned additives optionally present can be inter alia stabilizers, such as UV stabilizers, heat stabilizers, and free-radical scavengers, and/or can be processing aids, plasticizers, further polymers, or a combination or mixture thereof. The molding compositions can moreover include nano-scale fillers and/or nano-scale functional substances, examples being laminar minerals or metal oxides which increase the refractive index of ophthalmic lenses.

The invention moreover provides an article free from haze with at least one region or layer composed of the polyamide molding composition stated above. It is preferable that this is a foil, an insert, a profile, a tube, a hollow body, or an optically variable filter or particularly preferably an optical lens, with particular preference an ophthalmic lens.

The article, i.e. particularly the ophthalmic lens, preferably has a color gradient and/or has a photochromic coating, an antireflection coating, a scratch-resistant coating, an optical filter coating, a polarizing coating, an oxygen-barrier coating, or a combination of such coatings.

In particular for high-specification optical applications, e.g. in the form of ophthalmic lenses, it has proven advantageous for the glass transition temperature of an article composed of the polyamide molding composition to be above 90° C. or 100° C., preferably above 130° C., particularly preferably above 150° C.

The present invention moreover provides a process for production of an article as stated above, particularly preferably of an ophthalmic lens, which comprises molding a polyamide molding composition as stated above in an extrusion process, in an injection-molding process, or in an in-mold-coating process, to give the article, where the photochromic dye can be introduced in an advance and/or, if appropriate, in a downstream dip-bath-coating process and/or thermal transfer process (or in any other doping process) into the mixture composed of transparent polyamide and of further polymer. The photochromic article can also be a photochromic foil which can be applied to a substrate, preferably a conventional lens not photochromically modified, via lamination or adhesive bonding.

Such a process for production of a bulk-colored article can by way of example comprise compounding the photochromic dye together with the transparent homopolyamide and/or copolyamide and with the further polymer, where the dye can, by way of example, be added in the form of a liquid concentrate to the polymer melt composed of transparent homopolyamide and/or copolyamide and further polymer with the aid of a metering pump and/or the dye in the form of a solid is applied to the other components in a mixing drum, and where, if appropriate, application aids can also be used. In another possible method, the dye and the further polymer are processed to give a masterbatch with high color concentration which is preferably up to 30%, and the required amount of this masterbatch is processed with the transparent polyamide and/or copolyamide in an extruder to give pellets or is converted directly into the finished molding in the injection-molding machine.

The proposed polyamide molding composition can be used by way of example as constituent or coating of elements with spectral filter effect, e.g. in the form of spectacle lens, sun lens, corrective lens, or optical filter, or in the form of a switching assembly or optical signal processing, ski goggles, visor, safety spectacles, photorecording, display, optical data storage, of windows of buildings and of vehicles, etc. Secondly, it can also be used in connection with decorative elements or with structural elements, for example in the form of a spectacle frame, toy, or cover, particularly in the form of a mobile-telephone case, a part of electronic devices, a coating, particularly of packaging, of decorative items, of sports equipment, or of cladding, preferably in the automobile sector. In the case of the last applications it is sometimes sufficient to have photochromicity not in transmission but in reflection.

Further embodiments are described in the dependent claims and are included in the description.

### METHODS OF CARRYING OUT THE INVENTION

Examples will be used below to illustrate the invention. The examples are intended to indicate how a polyamide molding composition can be prepared and, for example, processed to give a molding, but are not intended to be interpreted as restricting the protected subject matter defined in the annexed patent claims.

### Examples 1 to 13 and Comparative Examples (CE) 1 to 5

First, the polymer mixtures, composed of transparent polyamide and of a block copolymer as further polymer, were prepared on a Collin Teach-Line ZK25T L/D=18 twin-screw extruder. The barrel temperatures were from 200 to 280° C. except in the feed zone, and the screw rotation rate was 120 to 250 rpm.

The spirooxazine dyes (OP 14 BLUE, OP 19 RED) were applied with the aid of Tween 20 (0.05% by weight) to the pellets of the transparent polyamides or to the polymer mixtures based on the transparent polyamides, in a mixing drum. These mixtures were then processed in an Arburg Allrounder 350-90-220D injection-molding machine to give plaques of dimensions 30×30×1 mm, the cylinder temperatures being from 200 to 260° C. and the mold temperature being from 20 to 60° C. The screw rotation rate was from 150 to 400 rpm.

The constitutions of the photochromic polyamide molding compositions used in each of the inventive examples are collated in tables 1 and 2, and those of the comparative examples are collated in table 3.

TABLE 1
Photochromic polyamide molding compositions of
inventive examples 1 to 9 (constitution in % by weight)

| | Example | | | | | | | | |
|---|---|---|---|---|---|---|---|---|---|
| | 1 | 2 | 3 | 4 | 5 | 6 | 7 | 8 | 9 |
| GRILAMID TR 90 | 89.8 | 89.8 | 89.8 | 69.8 | 89.8 | 89.6 | 89.8 | 89.8 | 89.8 |
| MACM 36 | | | | | | | | | 10.0 |
| GRILAMID ELY | 10.0 | | | | | | | | |
| 2475 | | | | | | | | | |
| GRILAMID ELY | | 10.0 | | | | | | | |
| 2694 | | | | | | | | | |
| FE 7334 | | | 10.0 | 30.0 | 10.0 | 10.0 | | | |
| PEBAX 5033 | | | | | | | 10.0 | | |
| PEBAX 7033 | | | | | | | | 10.0 | |
| OP 14 Blue | 0.2 | 0.2 | 0.2 | 0.2 | 0.4 | 0.2 | 0.2 | 0.2 | 0.2 |
| OP 19 Red | | | | | | 0.2 | | | |
| Photochromic | + | + | + | ++ | ++ | ++ | ++ | + | + |
| behavior | | | | | | | | | |
| Transmittance | 86 | 88 | 87 | 83 | 81 | 82 | 87 | 87 | 82 |
| (%) 600 nm in | | | | | | | | | |
| unexcited state | | | | | | | | | |
| Transmittance | 62 | 65 | 60 | 40 | 42 | 43 | 54 | 65 | 58 |
| (%) 600 nm in | | | | | | | | | |
| excited state*) | | | | | | | | | |
| Haze in | 2.2 | 2.2 | 1.9 | 3.7 | 1.9 | 1.9 | 2.2 | 2.4 | 2.6 |
| unexcited state | | | | | | | | | |

*)Irradiation time: 30 seconds

TABLE 2
Photochromic polyamide molding compositions of
inventive examples 10 to 13 (constitution in % by
weight):

Example

| | 10 | 11 | 12 | 13 |
|---|---|---|---|---|
| GRILAMID TR 90 | 89.8 | | 89.75 | 89.8 |
| MACM 18 | | 89.8 | | |
| PACM 36 | 10.0 | | | |
| FE 7334 | | 10.0 | 10.0 | 10.0 |
| Tinuvin 326 | | | 0.05 | |
| Polyshine Blue I | | | | 0.2 |
| OP 14 Blue | 0.2 | 0.2 | 0.2 | |
| Photochromic behavior | ++ | + | + | ++ |
| Transmittance (%) 600 nm | 85 | 84 | 82 | 61 |
| in unexcited state | | | | |
| Transmittance (%) 600 nm | 33 | 56 | 55 | 28 |
| in excited state*) | | | | |
| Haze in unexcited state | 2.8 | 2.5 | 1.9 | 2.0 |

*)Irradiation time: 30 seconds

The evaluation used in the tables for photochromic behavior, using the symbols −−, −, ◯, +, and ++ is based on qualitative visual assessment, and this is based on the rapidity of coloring and of fading (kinetics), and also on the depth of color achievable after irradiation.

Optical filtering in spectacle lenses has two functions. Firstly, the intensity of light reaching the eye is reduced, and secondly dangerous UV radiation is kept away from the eye. Since most photochromic dyes have intense absorption bands in the UV-A and UV-B region, even low concentrations of further UV absorbers (UV blockers), e.g. Tinuvin 326, are sufficient to achieve (inventive example 12) adequate UV-region absorption for spectacle lenses. In inventive example 12, therefore, even 0.05% by weight of Tinuvin 326 is sufficient to achieve a pronounced UV cutoff at 390 nm.

TABLE 3
Comparative examples CE1 to CE5 (constitution
in % by weight):

| | Example | | | | |
|---|---|---|---|---|---|
| | CE1 | CE2 | CE3 | CE4 | CE5 |
| GRILAMID TR 90 | 99.8 | | | | |
| MACM 18 | | 99.8 | | | |
| MACM 36 | | | | 99.8 | |
| PACM 36 | | | 99.8 | | |
| GRILAMID ELY 2475 | | | | | 99.8 |
| OP 14 Blue | 0.2 | 0.2 | 0.2 | 0.2 | 0.2 |
| Photochromic behavior | − | − | ++ | ++ | ++ |
| Transmittance (%) | 78 | 85 | 86 | 90 | 73 |
| 600 nm in unexcited | | | | | |
| state | | | | | |
| Transmittance (%) 600 nm | 70 | 78 | 36 | 46 | 30 |
| in excited state*) | | | | | |
| Haze in unexcited state | 1.6 | 2.2 | 2.5 | 2.9 | n.d. |

*)Irradiation time: 30 seconds
n.d.: not determined

From table 3 it can be concluded that comparative examples CE3, CE4, and also CE5 show positive results with respect to photochromic properties, but the mechanical properties of the materials are unsuitable for the inventive applications. Articles or layers produced from molding compositions corresponding to CE3-CE5 are too soft, or have too little heat resistance for such applications.

The optical measurements were carried out on Datacolor SF 600Plus color measurement equipment. An LED panel (10×8 diodes) with an emission maximum at about 415 nm (half-value width about 50 nm) was used for excitation of the dyes, applying a voltage of 27 V with a current of 0.05 ampere. This method was selected since the effect achieved by this irradiation was the same, with respect to the photochromic effect, as that occurring in January at the Applicant's location using natural insolation when the sky is cloudless. The spectral studies were carried out at a temperature of 20° C., and it is known that the kinetics of darkening and of fading are temperature-dependent.

The plaques were then placed, unirradiated, in the beam path of the flash lamp (transmittance measurement mode), and the absorption spectrum was measured from 400 to 700 nm. The plaque was then irradiated for 30 sec by means of the LED panel and the absorption spectrum was recorded immediately after removal of the radiation source. The absorption spectrum thus measured provides the maximum achievable darkening (color saturation) for the purposes of present considerations. However, because the reverse reaction of the dye to give its colorless form is sometimes very rapid, with resultant fading of the plaque, a maximum darkening thus determined is markedly below the genuine saturation achieved under irradiation, since up to 2 seconds can pass before the actual spectral measurement takes place. It is clear that the reverse reaction takes place most rapidly specifically in the state of maximum darkening, at which the highest concentration of excited dye molecules is present.

In order to measure the rate of fading, the absorption spectrum was recorded at various times after removal of the radiation source. The transmittance values determined at various junctures at wavelength 600 nm are collated in tables 4 and 5 for inventive examples 3 to 9. The Airwear® T5G lens from ESSILOR, France serves as comparison. This lens is a plastic lens (thickness 2 mm) composed of polycarbonate. The lens is either colored by dip-bath coating or coated with a photochromic lacquer. The transmittance of this lens was determined at 580 nm, because of the characteristic positioning of the absorption bands.

Markedly longer irradiation with the LED panel gave more marked darkening (saturation) than shown in the values of tables 1-3. By way of example, transmittance in inventive example 3 is reduced from 60% to 55% if the irradiation time is extended from 30 to 120 seconds.

TABLE 4
Transmittance (%) at 600 nm measured on
30 × 30 × 1 mm plaques as a function of time (fading);
plaques were previously irradiated for 30 seconds with
the LED panel; “0 seconds” therefore represents the
first measurement after the end of irradiation.

| | Plaque | Plaque | Plaque | Plaque |
|---|---|---|---|---|
| | composed of | composed of | composed of | composed of |
| | molding | molding | molding | molding |
| | composition | composition | composition | composition |
| | from | from | from | from |
| Time | inventive | inventive | inventive | inventive |
| (seconds) | example 3 | example 4 | example 5 | example 6 |
| 0 | 60 | 40 | 42 | 43 |
| 10 | 70 | 67 | 55 | 67 |
| 20 | 75 | 75 | 60 | 70 |
| 30 | 79 | 76 | 63 | 72 |
| 60 | 82 | 78 | 65 | 75 |
| 120 | 83 | 79 | 67 | 77 |
| 240 | 84 | 80 | 70 | 78 |
| 480 | 85 | 81 | 72 | 79 |
| 600 | 85 | 82 | 74 | 80 |
| 1200 | 86 | 82 | 77 | 81 |
| 1800 | 86 | 83 | 79 | 82 |
| Time for | 150 sec | 20 sec | 530 sec | 50 sec |
| darkening | | | | |
| to revert to | | | | |
| 20% | | | | |

TABLE 5
Transmittance (%) at 600 nm measured on
30 × 30 × 1 mm plaques as a function of time (fading);
plaques were previously irradiated for 30 seconds with
the LED panel; “0 seconds” therefore represents the
first measurement after the end of irradiation.

| | Plaque | Plaque | Plaque | |
|---|---|---|---|---|
| | composed of | composed of | composed of | |
| | molding | molding | molding | Comparative |
| | composition | composition | composition | lens: |
| | from | from | from | Airwear ® |
| Time | inventive | inventive | inventive | T5G |
| (seconds) | example 7 | example 8 | example 9 | (ESSILOR) |
| 0 | 54 | 65 | 58 | 43 |
| 10 | 64 | 74 | 66 | 50 |
| 20 | 70 | 76 | 68 | 56 |
| 30 | 74 | 77 | 70 | 62 |
| 60 | 77 | 79 | 72 | 73 |
| 120 | 78 | 80 | 74 | 86 |
| 240 | 79 | 81 | 76 | 88 |
| 480 | 80 | 82 | 77 | 88 |
| 600 | 82 | 83 | 78 | 89 |
| 1200 | 84 | 84 | 80 | 90 |
| 1800 | 86 | 85 | 81 | 91 |
| Time for | 450 sec | 650 sec | 480 sec | 90 sec |
| darkening | | | | |
| to revert | | | | |
| to 20% | | | | |

An impression of the speed of return of the various test specimens to the colorless state is given by the interval stated in tables 4 and 5 during which the darkening (transmittance in unexcited state minus transmittance at color saturation) shows 80% reversion. It is interesting that this interval for the decrease in depth of color of the photochromic polyamide compositions can be controlled within a wide range via selection of the added polymer. Values of from 20 to 650 seconds are realized in the present inventive examples.

Haze was determined at 23° C. using a Haze-Gard Plus from Byk-Gardener to ASTM D1003 (illuminant C).

The production process for the plaques of thickness 1 mm as stated in the tables above is not representative of particularly high-specification optical applications, since the molds used do not meet the requirements for such high-level applications. For comparison, taking the abovementioned inventive example 3 as a basis, i.e. the molding composition of inventive example 3, processing was again carried out to give a flat 2 mm plaque using a mold with better suitability for high-specification optical purposes (polished and under ideal injection-molding conditions). The following values were obtained here in the unirradiated state: transmittance=89%, haze=1.1. In other words, ideal manufacture of the moldings gives even higher transmittance and an even smaller haze value (in the unirradiated state).

The glass transition temperature of the transparent polyamide used inter alia in inventive example 3 is 155° C. The glass transition temperature of the blend with 10% of FE 7334 is 151° C. The marked improvement in the photochromic effect cannot therefore be explained here in the potentially obvious way solely via the macroscopic magnitude of the glass transition temperature, since this has been reduced by no more than 4° C. by virtue of the mixture. Instead, the local segment freedom of movement at the location of the dye molecules must be significantly increased, in order to achieve the desired effect. The higher local freedom of movement or the reduced local viscosity is brought about via flexible main chain sections or flexible side chains of the further polymer.

Table 6 collates the properties of pure Grilamid TR90 and of the mixture of inventive example 3.

TABLE 6
Comparison of mechanical properties of
Grilamid TR 90 in pure form and inventive example 3,
all values for conditioned state:

| | | | | Mixture from |
|---|---|---|---|---|
| Property | Standard | Unit | TR 90 | inventive example 3 |
| Tensile modulus | ISO 527 | MPa | 1600 | 1350 |
| of elasticity | | | | |
| Yield stress | ISO 527 | MPa | 60 | 53 |
| Elongation at | ISO 527 | % | 6 | 6 |
| yield | | | | |
| Tensile | ISO 527 | MPa | 45 | 46 |
| strength at | | | | |
| break | | | | |
| Elongation at | ISO 527 | % | 120 | 140 |
| break | | | | |
| Impact | ISO 179/2-leU | J | n.f. | n.f. |
| resistance, | | | | |
| 23° C. | | | | |
| Impact | ISO 179/2-leU | J | n.f. | n.f. |
| resistance, | | | | |
| −30° C. | | | | |
| Glass | ISO 11357 | ° C. | 155 | 151 |
| transition | | | | |
| temperature | | | | |

n.f.: no fracture

### Key:

FE7334 is a polyesteramide based on polyamide-12 and dimer diol, described in EP 0955326 B1 (glass transition temperature T_{g}=−30° C.). FE7334 contains polyester segments based on dimer acid and dimer diol.

GRILAMID TR 90: is a transparent, thermoplastically processable polyamide based on aliphatic and cycloaliphatic units. It corresponds to the systems proposed in EP 0 837 087, and is specifically in essence a homopolyamide of MACM12 type (where the numeral 12 represents dodecanedioic acid).

GRILAMID ELY 60 is a polyetheramide, GRILAMID ELY 2475 and 2694 are polyetheresteramides from EMS-CHEMIE AG, Switzerland (Tg=from −30 to −50° C.).

Tween 20 is a polyoxyethylene derivative of a fatty acid ester of sorbitan and is also termed Polysorbat 20, and is an application aid often used for various dyes.

PEBAX 5533 and 7033 are polyamide-12 block copolymers having ether segments from ARKEMA, France (T_{g}=about −40° C.).

NCC® dyes OP 14 BLUE and OP 19 RED from New Prismatic Enterprise Co., Ltd., Taiwan were used as photochromic dyes.

Polyshine Blue I was also used as photochromic dye and is obtainable from Polychrom Co., Ltd. (Korea).

Tinuvin 326, obtainable from CIBA SC AG, Switzerland, was also used as UV absorber:

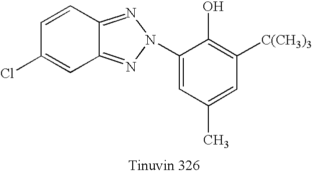

The relative viscosity (ηᵣₑₗ) was measured according to DIN EN ISO 307 in a 0.5 weight % solution in m-cresol at a temperature of 20° C.

The glass transition temperature (T_{g}) was determined according to ISO 11357-1/2;

The differential scanning calorimetry (DSC) was carried out with a heating rate of 20K/min. The values are given for the onset.

### Further Inventive Examples

Further examples 14-21 are stated together with the properties determined in them in additional table 7:

| | Inventive example | | | | | | | |
|---|---|---|---|---|---|---|---|---|
| | 14 | 15 | 16 | 17 | 18 | 19 | 20 | 21 |
| GRILAMID | | | 84.3 | 86.8 | 86.8 | | | |
| TR 90 | | | | | | | | |
| (ηᵣₑₗ = 1.75) | | | | | | | | |
| GRILAMID | 76.8 | 66.8 | | | | 86.8 | 86.8 | 86.8 |
| TR 90 | | | | | | | | |
| (ηᵣₑₗ = 1.65) | | | | | | | | |
| FE7314 | 10.0 | 10.0 | 10.0 | 10.0 | | 10.0 | | |
| (ηᵣₑₗ = 1.35) | | | | | | | | |
| FE7314 | | | | | 10.0 | | 10.0 | |
| (ηᵣₑₗ = 1.58) | | | | | | | | |
| FE7313 | | | | | | | | 10.0 |
| (ηᵣₑₗ = 1.62) | | | | | | | | |
| XE3828 | | | 2.5 | | | | | |
| GRILAMID | 10.0 | 20.0 | | | | | | |
| L16 | | | | | | | | |
| (ηᵣₑₗ = 1.66) | | | | | | | | |
| XE3680 | 3.0 | 3.0 | 3.0 | 3.0 | 3.0 | 3.0 | 3.0 | 3.0 |
| OP 14 Blue | 0.2 | 0.2 | 0.2 | 0.2 | 0.2 | 0.2 | 0.2 | 0.2 |
| Gate marks | no | no | yes | yes | no | yes | no | no |
| Photochromic | ++ | ++ | + | + | + | + | + | + |
| behavior | | | | | | | | |
| Transmittance | 89 | 90 | 90 | 88 | 89 | 88 | 89 | 90 |
| (%) at 600 nm | | | | | | | | |
| in unexcited | | | | | | | | |
| state | | | | | | | | |
| Transmittance | 46 | 40 | 60 | 62 | 62 | 60 | 60 | 58 |
| (%) at 600 nm | | | | | | | | |
| in excited | | | | | | | | |
| state*) | | | | | | | | |
| Haze in | 1.0 | 1.6 | 1.8 | 3.7 | 1.2 | 3.9 | 1.8 | 1.0 |
| unexcited | | | | | | | | |
| state | | | | | | | | |

*)Irradiation time: 30 seconds

### Key:

FE7313, FE7314: polyesteramide based on polyamide-12 and dimer diol; FE7314 also contains polyester segments based on dimer acid and dimer diol.

XE3680 is a heat/UV masterbatch based on polyamide-12.

XE2828 is a polyamide-12 oligomer whose number-average molar mass is about 2000 g/mol, having mainly non-condensable alkyl end groups.

GRILAMID L16 is a low-viscosity polyamide-12.

### Results:

Haze and photochromic effect are improved via addition of low-viscosity polyamide-12 (cf. inventive example 14 and inventive example 15).

Furthermore, addition of polyamide-12 and polyamide oligomer permits processing of the photochromic polyamide molding composition under gentler conditions or incorporation of the photochromic dye into the thermoplastic molding composition under gentler conditions, thus permitting substantial inhibition of degradation of the unstable photochromic dye during the extrusion and/or injection-molding process.

The gate marks (round plaque, 70×2 mm) markedly visible in inventive example 17 can be avoided by various measures. Addition of 10% by weight or more of a low-viscosity polyamide-12 is effective in inhibiting formation of gate marks.

Gate marks can likewise be avoided if the ratio of solution viscosities of the transparent polyamide/copolyamide and of the polymer component whose glass transition temperature is below 80° C. is smaller than 1.2, particularly smaller than 1.1 (see inventive example 20 compared with inventive example 19 and inventive example 18 compared with inventive example 17, and also inventive example 21).

Haze, too, decreases for identical chemical constitution of the polymer components as the ratio of the solution viscosities of the two polymer components falls. In inventive example 19, with a ratio of 1.22 for the solution viscosities, the observed haze is 3.9, whereas in IE20 with a lower ratio of solution viscosities of 1.04, the result is markedly lower haze of 1.8.

Although addition of polyamide-12 oligomer does not necessarily always inhibit formation of gate marks, it makes processing easier overall, by virtue of lower melt viscosity and longer flow path.

What is claimed is:

1. A polyamide molding composition comprising
a proportion by weight of from 50 to 99% by weight of at least one transparent homopolyamide and/or copolyamide;
a proportion by weight of from 1 to 50% by weight of at least one further polymer whose glass transition temperature is below 80° C.;
a proportion by weight of from 0.001 to 2.0% by weight of at least one photochromic dye;
and also, optionally,
further dyes and/or additives.

2. The polyamide molding composition as claimed in claim 1, wherein the glass transition temperature of the further polymer is below 40° C., preferably below 25° C.

3. The polyamide molding composition as claimed in claim 1 or 2, wherein the glass transition temperature of the further polymer is below 0° C., preferably in the range from (−60)-(−20)° C.

4. The polyamide molding composition as claimed in any of the preceding claims, wherein the further polymer is a polyamide based on cycloaliphatic diamines and aliphatic dicarboxylic acids having from 6 to 40 carbon atoms, the cycloaliphatic diamine preferably being MACM and/or PACM, and the entire polyamide particularly preferably being MACM36 and/or PACM36, and/or wherein the further polymer is a block copolymer having soft segments, where the glass transition temperature of the soft segments is preferably below 40° C., preferably below 25° C.

5. The polyamide molding composition as claimed in claim 4, wherein the further polymer is a polyamide block copolymer having soft segments, preferably is a polyamide-12 block copolymer, the soft segments preferably being polyether soft segments and/or polyester soft segments and/or polysiloxane soft segments and/or polyolefin soft segments and/or polyacrylate soft segments, preferred polyether segments being those based on the monomers ethylene oxide and/or propylene oxide and/or tetrahydrofuran.

6. The polyamide molding composition as claimed in any of the preceding claims, wherein the further polymer is a polymer selected from the following group: polyester having soft segments; TPU elastomers having soft segments; acrylate polymer; methacrylate polymer, particularly preferably having long pendent groups; polycarbonate copolymer; styrene copolymer, preferably based on acrylonitrile, butadiene, acrylic esters, methacrylic esters; polyolefin, particularly grafted; ethylene copolymers, particularly based on propene, butene, pentene, hexene, octene, decene, undecene, butadiene, styrene, acrylonitrile, isoprene, isobutylene, derivatives of (meth)acrylic acid, vinyl acetate, tetrafluoroethylene, vinylidene fluoride, hexafluoropropene, and 2-chlorobutadiene; polyisobutylene; polybutyl acrylate, and also combinations and mixtures thereof.

7. The polyamide molding composition as claimed in any of the preceding claims, wherein the proportion by weight present of the transparent homopolyamide and/or copolyamide is from 70 to 99% by weight, particularly preferably from 80 to 98% by weight.

8. The polyamide molding composition as claimed in any of the preceding claims, wherein the proportion by weight present of the further polymer is from 1 to 30% by weight, particularly preferably from 2 to 20% by weight.

9. The polyamide molding composition as claimed in any of the preceding claims, wherein the transparent homopolyamide and/or copolyamide is a polyamide based on cycloaliphatic diamines and on aliphatic dicarboxylic acids having from 6 to 36 carbon atoms or is a mixture of such homopolyamides and/or copolyamides.

10. The polyamide molding composition as claimed in claim 8, wherein the cycloaliphatic diamines are MACM and/or PACM.

11. The polyamide molding composition as claimed in claim 9 or 10, wherein the aliphatic dicarboxylic acid is an aliphatic dicarboxylic acid having 10, 12, 14 or 18 carbon atoms.

12. The polyamide molding composition as claimed in any of claims 9 to 11, wherein the transparent polyamide is a homopolyamide selected from the group of MACM12, MACM14, MACM18 and/or is a copolyamide selected from the group of MACM12/PACM12, MACM14/PACM14, MACM18/PACM18.

13. The polyamide molding composition as claimed in any of the preceding claims, wherein the transparent homopolyamide and/or copolyamide is a polyamide based on aromatic dicarboxylic acids having from 8 to 18 carbon atoms, or is a mixture of such homopolyamides and/or copolyamides, preferably based on lactams and/or aminocarboxylic acids, the aromatic dicarboxylic acids preferably being TPA and/or IPA.

14. The polyamide molding composition as claimed in claim 13, wherein the transparent homopolyamide and/or copolyamide is a polyamide selected from the group of: 6I6T, TMDT, 6I/MACMI/MACMT, 6I/6T/MACMI, MACMI/MACM36, 6I, 12/PACMI, 12/MACMI, 12MACMT, 6/PACMT, 6/6I, 6/IPDT, or a mixture thereof.

15. The polyamide molding composition as claimed in any of the preceding claims, wherein the transparent homopolyamide and/or copolyamide is a polyamide based on at least one dicarboxylic acid and on at least one diamine having an aromatic ring, preferably based on MXD, where the dicarboxylic acid can be aromatic and/or aliphatic, the material preferably being 6I/MXDI.

16. The polyamide molding composition as claimed in any of the preceding claims, wherein the solution viscosity (ηᵣₑₗ) of the transparent homopolyamide and/or copolyamide is from 1.3 to 2.0, particularly preferably from 1.40 to 1.85, and/or its glass transition temperature T_{g} is above 90° C., preferably above 110° C., particularly preferably above 130° C.

17. The polyamide molding composition as claimed in any of the preceding claims, wherein the photochromic dye is a dye which is reversibly excitable with UV or short-wave VIS, preferably being a dye based on spirooxazines.

18. The polyamide molding composition as claimed in any of the preceding claims, wherein the additives are stabilizers, such as UV stabilizers, heat stabilizers, or free-radical scavengers, and/or are processing aids, plasticizers, or further polymers, and/or are functional additives, preferably for influencing optical properties, e.g. particularly refractive index, or are a combination or mixture thereof.

19. The polyamide molding composition as claimed in any of the preceding claims, which comprises polyamide-12, preferably low-viscosity polyamide-12.

20. The polyamide molding composition as claimed in claim 19, wherein the solution viscosity (ηᵣₑₗ) of the low-viscosity polyamide-12 is from 1.5 to 2, preferably from 1.6 to 1.9.

21. The polyamide molding composition as claimed in any of the preceding claims, which comprises a polyamide oligomer, particularly preferably a polyamide-12 oligomer.

22. The polyamide molding composition as claimed in claim 21, wherein the polyamide oligomer is a polyamide-12 oligomer whose average molar mass is from 1500 to 2500 g/mol, preferably having mainly non-condensable alkyl end groups.

23. The polyamide molding composition as claimed in any of the preceding claims, wherein the ratio of the solution viscosities (ηᵣₑₗ) of the transparent homopolyamide and/or copolyamide and of the further polymer whose glass transition temperature is below 80° C. is smaller than 1.2, particularly smaller than 1.1.

24. A transparent, preferably haze-free article having at least one region or one layer composed of a polyamide molding composition as claimed in any of the preceding claims.

25. An article as claimed in the preceding claim for high-specification optical applications, whose transmittance is more than 70%, preferably more than 80%, in the wavelength range from 500 to 700 nm, and/or whose haze is less than 5, preferably less than 3, for a thickness of the layer composed of the polyamide molding composition of 2 mm.

26. The article as claimed in claim 24 or 25, which is a foil, a profile, a tube, a hollow body, or an optically variable filter or an optical lens, preferably is an ophthalmic lens, particularly preferably is an element with spectral filter action, for example in the form of a spectacle lens, sun lens, corrective lens, or optical filter, or in the form of a switching assembly or optical signal processing, ski goggles, visor, safety spectacles, photorecording, display, optical data storage, or windows of buildings and of vehicles, or is a decorative element or a structural element, for example in the form of a spectacle frame, toy, or cover, particularly in the form of a mobile-telephone case, a part of electronic devices, a coating, particularly of packaging, of decorative items, of sports equipment, or of cladding, preferably in the automobile sector.

27. The article as claimed in any of claims 24 to 26, which has a color gradient and/or has a photochromic coating, an antireflective coating, a scratch-resistant coating, an optical filter coating, a polarizing coating, an oxygen-barrier coating, or a combination of such coatings.

28. The article as claimed in any of claims 24 to 27, wherein the glass transition temperature of the region or the layer composed of the polyamide molding composition is above 90° C., preferably above 100° C., particularly preferably above 130° C.

29. The process for production of an article as claimed in any of claims 24 to 28, which comprises molding a polyamide molding composition as claimed in any of claims 1 to 23 in an extrusion process, in an injection-molding process, or in an in-mold-coating process, to give the article, where the photochromic dye can, if appropriate, be introduced in a downstream immersion-bath process and/or thermal transfer process into the mixture composed of transparent polyamide and of further polymer, and where the photochromic article can also be a foil which can be applied to a substrate, preferably an optical lens, via lamination or adhesive bonding.

30. The process for production of a bulk-colored molding as claimed in claim 28, which comprises compounding the photochromic dye together with the transparent homopolyamide and/or copolyamide and with the further polymer, where the dye can be added in the form of a liquid concentrate to the polymer melt composed of transparent homopolyamide and/or copolyamide and further polymer with the aid of a metering pump, and/or the dye is applied in the form of solid to the other components in a drum mixer, and where use may also be made, if appropriate, of application aids.

31. The process for production of a bulk-colored molding, as claimed in claim 29, wherein the dye and the further polymer are processed to give a masterbatch with high color concentration which is preferably up to 30%, and the required amount of this masterbatch is processed with the transparent polyamide and/or copolyamide in an extruder to give pellets or is converted directly into the finished molding in the injection-molding machine.
